(19) United States
(12) Patent Application Publication
(10) Pub. No.: US 2006/0229866 A1
(43) Pub. Date: Oct. 12, 2006

(54) Apparatus and method for deterministically constructing a text question for application to a data source

(75) Inventors: Nicholas Guy Kellet, Kelowna (CA); Steve Kopp, Paris (FR); Luke William Evans, West Vancouver (CA)

Correspondence Address: COOLEY GODWARD, LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 11/102,488

(22) Filed: Apr. 7, 2005

(51) Int. Cl. G06F 17/27

(52) U.S. Cl. 704/9

(57) ABSTRACT

A method of deterministically constructing a text question for application to a data source includes supplying a user with an initial text question. The user is allowed to alter a sentence component of the text question to form an altered sentence component. When the altered sentence component in combination with remaining sentence components creates an invalid question, sentence components are supplied to insure the selection of a valid question. A data source query is constructed from the initial text question and at least one altered sentence component. The data source query is applied to a data source to produce data results. The data results are presented to the user.

### CROSS-REFERENCES TO RELATED APPLICATIONS

This application is related to the following concurrently filed, commonly owned patent applications, each of which is incorporated by reference herein:

Apparatus and Method for Data Modeling Business Logic, Ser. No. ______, filed Apr. 7, 2005;

Apparatus and Method for Utilizing Sentence Component Metadata to Create Database Queries, Ser. No. ______, filed Apr. 7, 2005; and

Apparatus and Method for Constructing Complex Database Query Statements Based on Business Analysis Comparators, Ser. No. ______, filed Apr. 7, 2005.

### BRIEF DESCRIPTION OF THE INVENTION

This invention relates generally to accessing digital data. More particularly, this invention relates to a technique for deterministically constructing a text question that can be converted to a data source query for application to a digital data source.

### BACKGROUND OF THE INVENTION

Business intelligence generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and, data management systems, such as relational databases or On Line Analytic Processing (OLAP) systems used to collect, store, and manage raw data.

Given the disparate roles performed by business intelligence tools and the vast amount of data that they are applied against, there are ongoing efforts to simplify their use. In their most successful manifestations, non-technically trained personnel can use business intelligence tools. To achieve this, it is important to insulate non-technically trained personnel from the complexities of the underlying data sources. Users of business intelligence tools generally have knowledge of the information that they want; the challenge is translating this knowledge into appropriate queries that can be applied to an underlying data source.

Ideally, a business intelligence tool provides an interface that allows a user to think on his or her own terms, but still allows for data source queries that can be efficiently applied against a data source. Since business intelligence users commonly think in terms of text-based queries, it would be desirable to provide such users with text-based queries that can be used directly and/or that can be used with user-selected modifications to the original text-based queries. Ideally, such a system would only permit the construction of text-based queries that can be converted into data source queries.

### SUMMARY OF THE INVENTION

The invention includes a method of deterministically constructing a text question for application to a data source. The method includes supplying a user with an initial text question. The user is allowed to alter a sentence component of the text question to form an altered sentence component. When the altered sentence component in combination with remaining sentence components creates an invalid question, sentence components are supplied to insure the selection of a valid question. A data source query is constructed from the initial text question and at least one altered sentence component. The data source query is applied to a data source to produce data results. The data results are presented to the user. The invention also includes a computer readable medium storing executable instructions to deterministically construct a text question for application to a data source. The executable instructions include executable instructions to supply a user with an initial text question. The user is allowed to alter a sentence component of the text question to form an altered sentence component. When the altered sentence component in combination with remaining sentence components creates an invalid question, sentence components are supplied to insure the selection of a valid question. A data source query is constructed from the initial text question and at least one altered sentence component. The data source query is applied to a data source to produce data results. The data results are presented to the user.

The invention provides a technique for text-based queries, which are familiar to all types of end-users. Advantageously, the invention supplies text-based queries to users and allows users to manipulate the text-based queries solely in ways that will result in a data source query.

### BRIEF DESCRIPTION OF THE FIGURES

The invention is more fully appreciated in connection with the following detailed description taken in conjunction with the accompanying drawings, in which:

FIG. 1 illustrates a computer constructed in accordance with an embodiment of the invention.

FIG. 2 illustrates processing operations associated with an embodiment of the invention.

FIG. 3 illustrates a simple question panel configured in accordance with an embodiment of the invention.

FIG. 4 illustrates the alteration of sentence components of the question panel of FIG. 3 in accordance with an embodiment of the invention.

FIG. 5 illustrates data results produced by the exemplary question panels of FIGS. 3 and 4.

FIG. 6 illustrates another question panel configured in accordance with an embodiment of the invention.

FIG. 7 illustrates the alteration of sentence components of the question panel of FIG. 6 in accordance with an embodiment of the invention.

FIG. 8 illustrates the selection of data result formatting options in accordance with an embodiment of the invention.

FIG. 9 illustrates data results produced by the exemplary question panels of FIGS. 6-8.

FIG. 10 illustrates an expression editor to produce personal filter criteria in accordance with an embodiment of the invention.

FIG. 11 illustrates various question templates that may be used in accordance with an embodiment of the invention.

Like reference numerals refer to corresponding parts throughout the several views of the drawings.

### DETAILED DESCRIPTION OF THE INVENTION

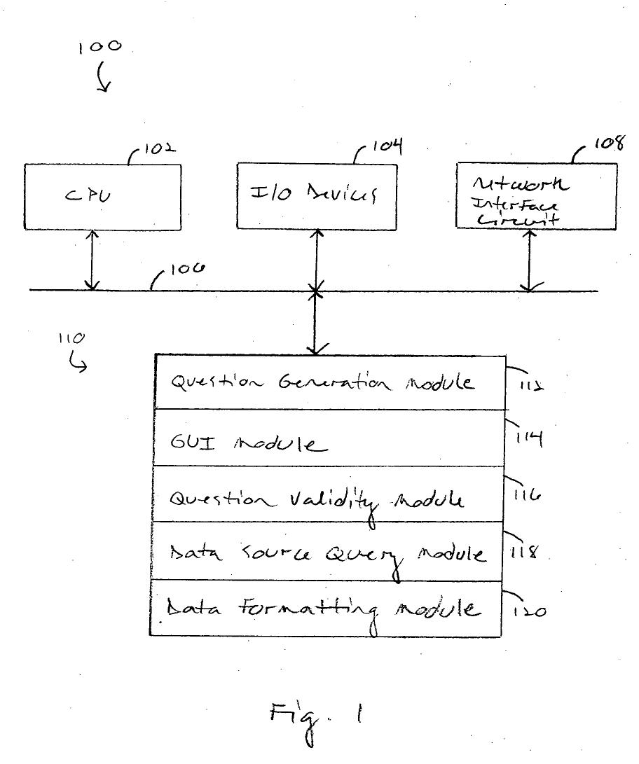

FIG. 1 illustrates a computer 100 configured in accordance with an embodiment of the invention. The computer 100 includes standard components, including a central processing unit 102 and input/output devices 104, which are linked by a bus 106. The input/output devices 104 may include a keyboard, mouse, touch screen, monitor, printer, and the like. A network interface circuit 108 is also connected to the bus 106. The network interface circuit 108 provides connectivity to a network (not shown), thereby allowing the computer 100 to operate in a networked environment.

A memory 110 is also connected to the bus 106. The memory 110 stores executable instructions to implement operations of the invention. In one embodiment, the executable instructions include a question generation module 112. The question generation module 112 includes executable instructions to provide an initial question to a user. The initial question may be supplied to the user through a default selection or through a previous specified question selection. Question selection may be predicated upon a template of questions. For example, the template of questions may be divided by enterprise function, such as marketing, finance, and the like. The question may also be based upon previous customized questions, either created by the user or by another user. Alternately, the question may be selected from a list of frequently asked questions or a list of recently asked questions. In one embodiment of the invention, predicted questions may be supplied based upon the previous behavior of a user or group of users. As discussed below, questions may be based upon personal filter criteria established by a user.

Memory 110 also stores a Graphical User Interface (GUI) module 114. The GUI module 114 may rely upon standard techniques to produce graphical components, such as pull-down menus, radio buttons, and the like, examples of which are discussed below.

Memory 110 also stores a question validity module 116. The question validity module includes executable instructions to insure that only valid questions are presented to a user or constructed by a user. In one embodiment, the question validity module includes executable instructions to insure that all displayed components form a valid question. A valid question is defined as a text question that can be translated to a legitimate data source query. In another embodiment, the question validity module includes executable instructions to insure that all selectable components (i.e., those displayed and those available for selection) form a valid question, regardless of the component combination. This may require the deletion of selectable components based upon previously selected components. Alternately, this may allow the addition of selectable components based upon previously selected components. In one embodiment, the question validity module 116 includes executable instructions to predict a complete text-based question based upon the selection of one or more selectable components. For example, the selection of two selectable components may result in the question validity module 116 generating a new text-based question with new components. The new components may be automatically selected based upon the previous behavior of the user or based upon the previous behavior of another group of users.

The question validity module 116 insures that in the dynamic operation of constructing a text-based query, only legitimate queries are generated. Thus, the module deterministically constructs a text question that will be successfully applied to a data source. This stands in sharp contrast to prior art techniques in which a text-based question is constructed, but might fail upon execution because of improper form and/or content. Such a run-time failure is advantageously prevented through use of the question validity module of the invention.

A data source query module 118 is also stored in memory 110. The data source query module 118 includes executable instructions to translate the final text-based query into a data source query, e.g., a Structured Query Language (SQL) query. As previously indicated, the question validity module 116 insures that only valid text questions are generated, therefore, the data source query module 118 is always in a position to translate a text-based query into a data source query. The data source query module 118 also includes executable instructions to apply the generated data source query to an underlying data source, which may form a portion of computer 100 or may be accessed as a separate networked machine through the network interface circuit 108.

The question validity module 116 and the data source query module 118 may be implemented in accordance with any number of techniques, including those described in the following concurrently filed, commonly owned patent applications, each of which is incorporated by reference herein: Apparatus and Method for Data Modeling Business Logic, Ser. No. ______, filed Apr. 7, 2005; Apparatus and Method for Utilizing Sentence Component Metadata to Create Database Queries, Ser. No. ______, filed Apr. 7, 2005; and Apparatus and Method for Constructing Complex Database Query Statements Based on Business Analysis Comparators, Ser. No. ______, filed Apr. 7, 2005.

Memory 110 may also store a data formatting module 120. The data formatting module includes executable instructions to produce user-selectable data output formatting options. The data output formatting options may directly correspond to displayed sentence components of the text-based question. In addition, the data output formatting options may include components that are not directly specified by the displayed sentence components, as will be illustrated below.

The executable modules stored in memory 110 are exemplary. It should be appreciated that the functions of the modules maybe combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

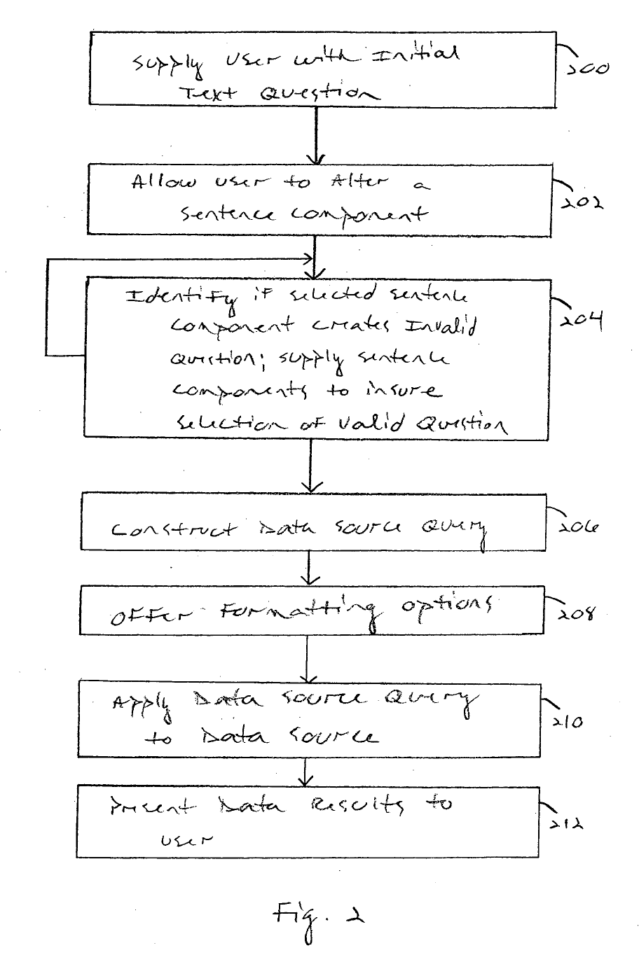

FIG. 2 illustrates processing operations that may be implemented by the computer 110. The first processing operation of FIG. 2 is to supply a user with an initial text question 200. The question generation module 112 may be used to implement this operation. As previously indicated, the initial text question may be generated from a template, previously customized questions frequently asked questions, recently asked questions, and/or predicated questions.

The next operation of FIG. 2 is to allow a user to alter a sentence component 202. As will be shown through various examples below, alteration of a sentence component may be implemented through the use of pull-down menus. The GUI module 114 may be used to implement this operation.

The next processing operation of FIG. 2 is to identify if a selected sentence component creates an invalid question. If so, sentence components are supplied to insure the selection of a valid question 204. The question validity module 116 is used to implement this operation. As previously indicated, the question validity module 116 can be implemented to insure that all displayed components form a valid question. The question validity module 116 may also be implemented to insure that all selectable components potentially form a valid question, regardless of the combination of components. The operation of block 204 may be repeated until the user indicates that a final text-based question is prepared.

The next processing operation of FIG. 2 is to construct a data source query 206. This operation may be implemented using the data source query module 118. As previously indicated, the data source query module translates the text-based question into an equivalent data source (e.g., SQL) query.

An optional additional step is to offer formatting options 208. As will be illustrated below, the formatting options provide various user-selectable data presentation options to a user. The data formatting module 120 may be used to implement this operation.

The data source query (and the data formatting options, if selected) is then applied to a data source 210. The query module 118 may be used to implement this operation.

Finally, data results are presented to the user 212. The presentation operation may be implemented using the GUI module 114.

The apparatus and method of the invention has been fully described. Attention now turns to various specific examples to more fully illuminate the nature and benefits of the invention.

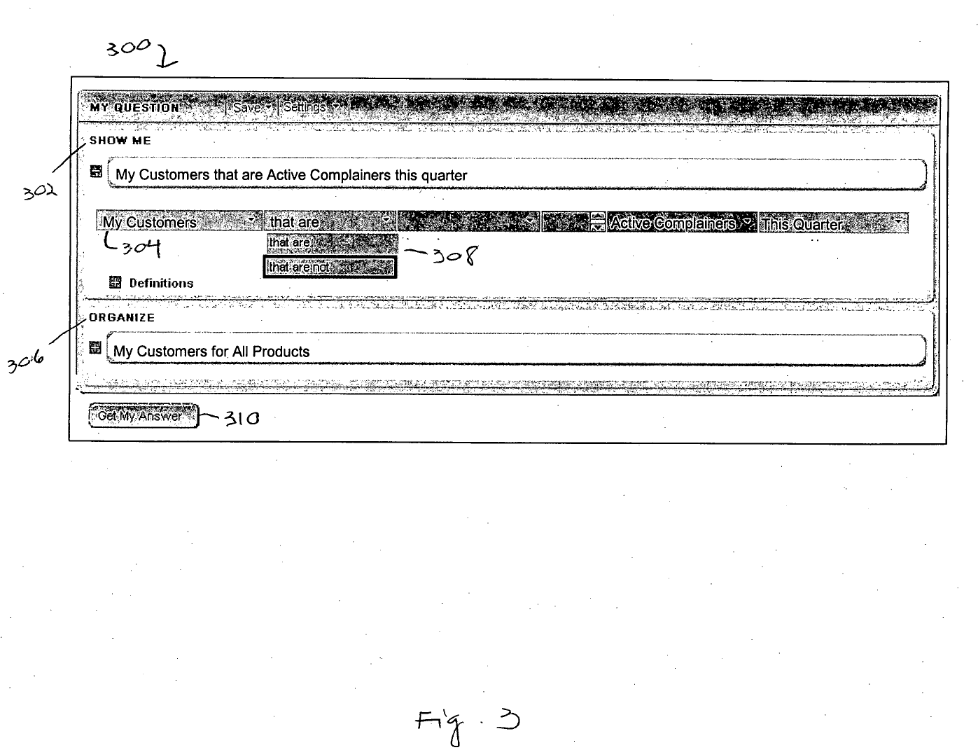

FIG. 3 illustrates a graphical user interface (GUI) 300 used to implement an embodiment of the invention. The GUI 300 includes a question panel 302, which displays a text-based question with selectable components 304. The GUI 300 also includes a formatting panel 306, which provides options for formatting data produced in response to the text-based query generated in the question panel 302.

FIG. 3 illustrates that a pull-down menu 308 is used to select components of the text-based question 304. By selecting a new component (e.g., “that are not”) in the pull-down menu 308, a new text-based question is formed. The question validity module 116 is then invoked to confirm that the selected components of the text-based question can be translated into a valid data source query. Alternately, the question validity module 116 may be implemented so that a valid data source query was insured by only supplying selectable data components that would produce a valid data source query.

In the example of FIG. 3, the text-based query includes a subject (i.e., “Customers”), a verb (i.e., “are”), a predicate noun (i.e., “complainers”), and a time period (i.e., “this quarter”). These are common components in the text-based queries utilized in accordance with embodiments of the invention. However, alternate and additional sentence components may also be used in accordance with embodiments of the invention.

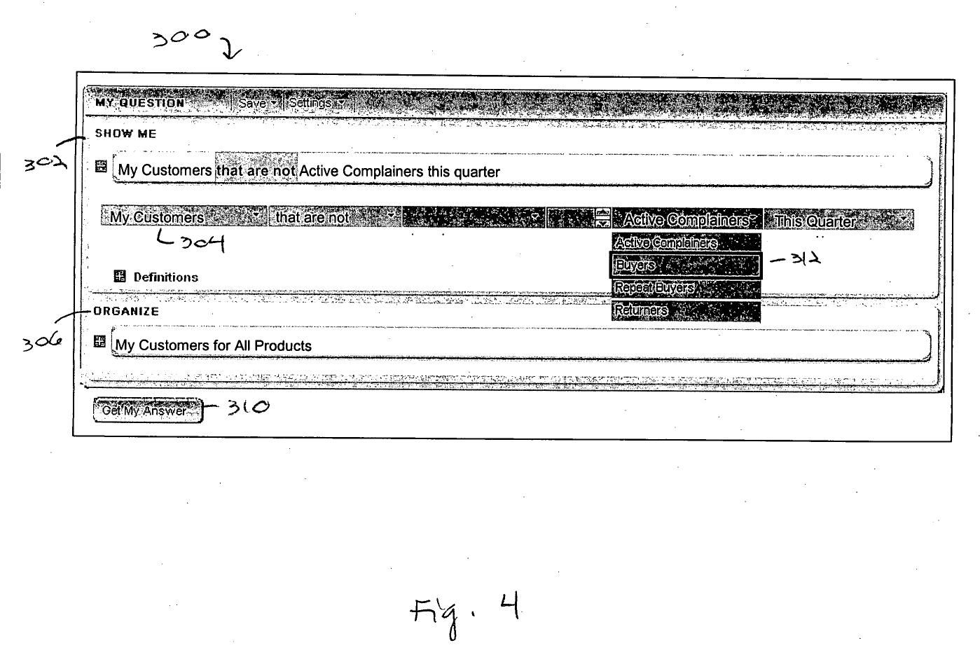

FIG. 4 generally corresponds to FIG. 3, but in FIG. 4 a pull-down menu 312 is activated for the selection of different selectable components (i.e., different predicate nouns, such as “buyers”, “returners”, etc.). The other sentence components also have associated pull-down menus, although not explicitly shown in this example.

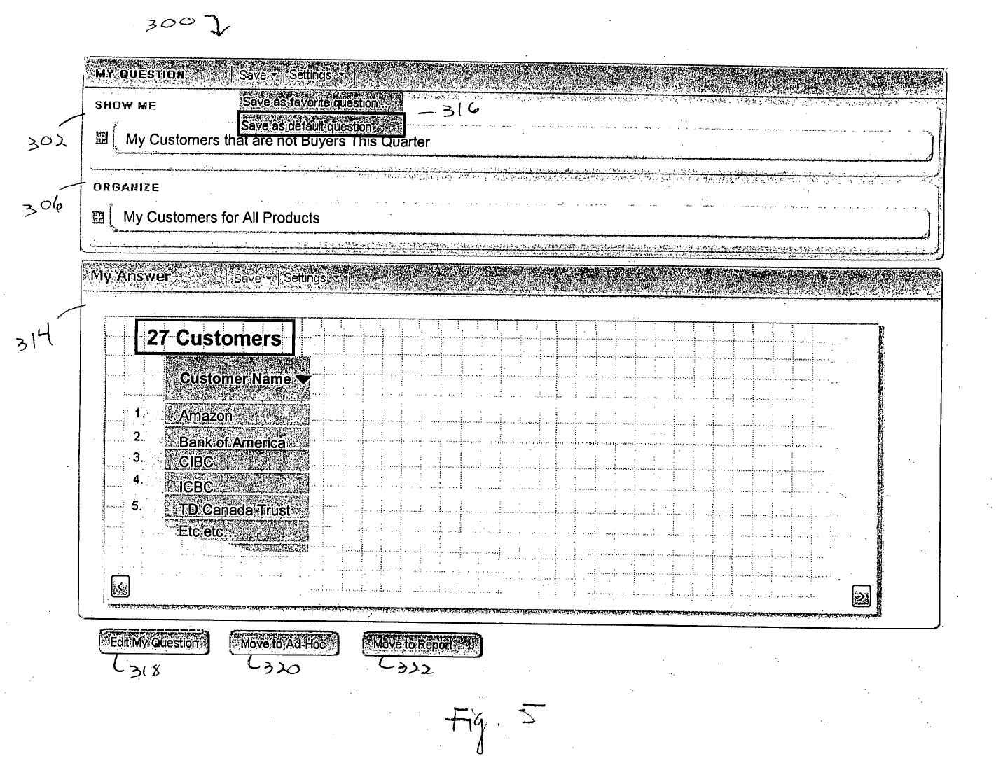

FIGS. 3 and 4 can be used to illustrate several of the processing operations associated with FIG. 2. For example, FIG. 3 illustrates that a user is supplied with an initial text question (block 200 of FIG. 2). FIGS. 3 and 4 illustrate that a user is allowed to alter one or more sentence components (block 202 of FIG. 2). When the “Get My Answer” button 310 is selected, a data source query is constructed (block 206 of FIG. 2) and is subsequently applied to a data source (block 210 of FIG. 2). FIG. 5 illustrates the result of this operation.

FIG. 5 illustrates the question panel 302 with the text-based question that was constructed, as shown in FIGS. 3 and 4. The figure also illustrates a results panel 314, which shows the results of the text-based query. FIG. 5 also illustrates that the question may be saved using pull-down menu 316. The pull-down menu 316 provides options, such as “Save as favorite question” and “Save as default question”. The question generation module 112 can then process this information. As previously discussed, the question generation module 112 is used to initially present a question to a user. The question may be presented based upon any number of criteria. In FIG. 5, a user's own previously customized question is saved as a default question for subsequent interactive sessions. The question generation module 112 may also present a question based upon a template, frequently asked questions, recently asked questions, predicted questions and the like.

FIG. 5 also illustrates an “edit my question button”. If selected, the user would be once again presented with a GUI, such as shown in FIGS. 3 and 4. A “Move to Ad-Hoc” button 320 and a “Move to Report” button 322 are also shown in FIG. 5. The “Move to Ad-Hoc” button 320 is used to move a question to an ad-hoc question repository. The “Move to Report” button is used to move the results information to a report that can be distributed.

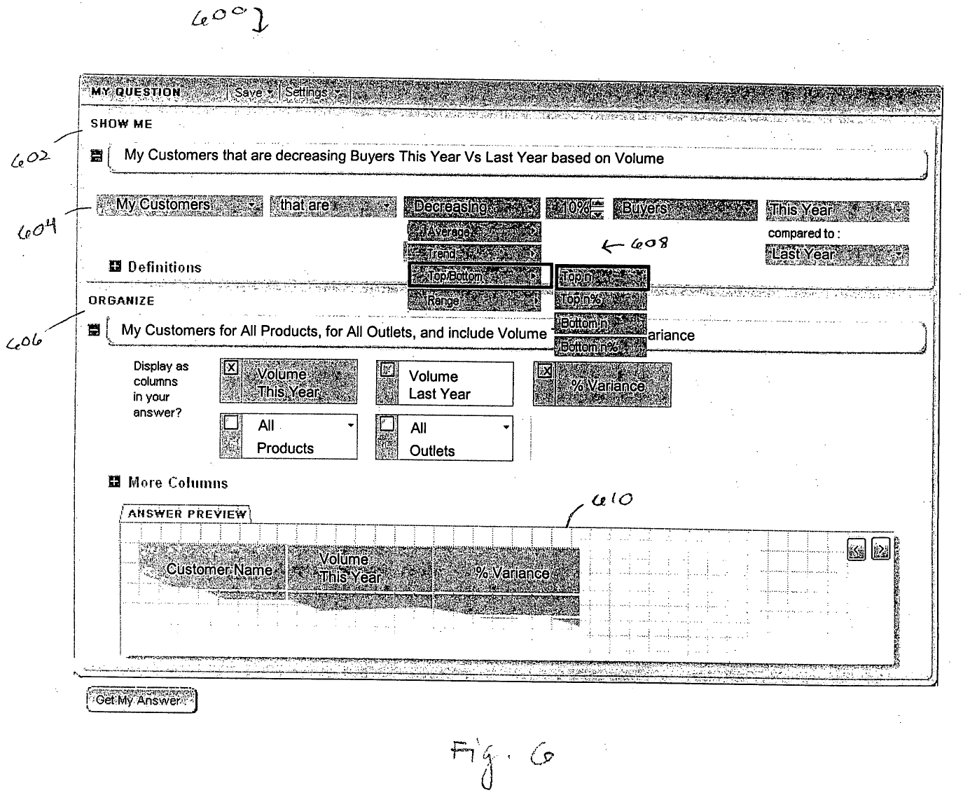

FIG. 6 illustrates another GUI 600 that may be used in accordance with an embodiment of the invention. The GUI 600 includes a question panel 602 with a text-based question 604. In this example, cascaded pull-down menus 608 are supplied for selectable components of the sentence 604. The formatting panel 606 in this example is more sophisticated than in the previous example. Observe that the formatting panel 606 has formatting options that correspond to selectable components of the sentence 604 (e.g., “Volume This Year”). The formatting panel 606 also has formatting options that do not appear in the selectable components of the sentence 604 (e.g., “All Products”). An Answer Preview field 610 provides a preview based upon the selections made in the formatting panel 606.

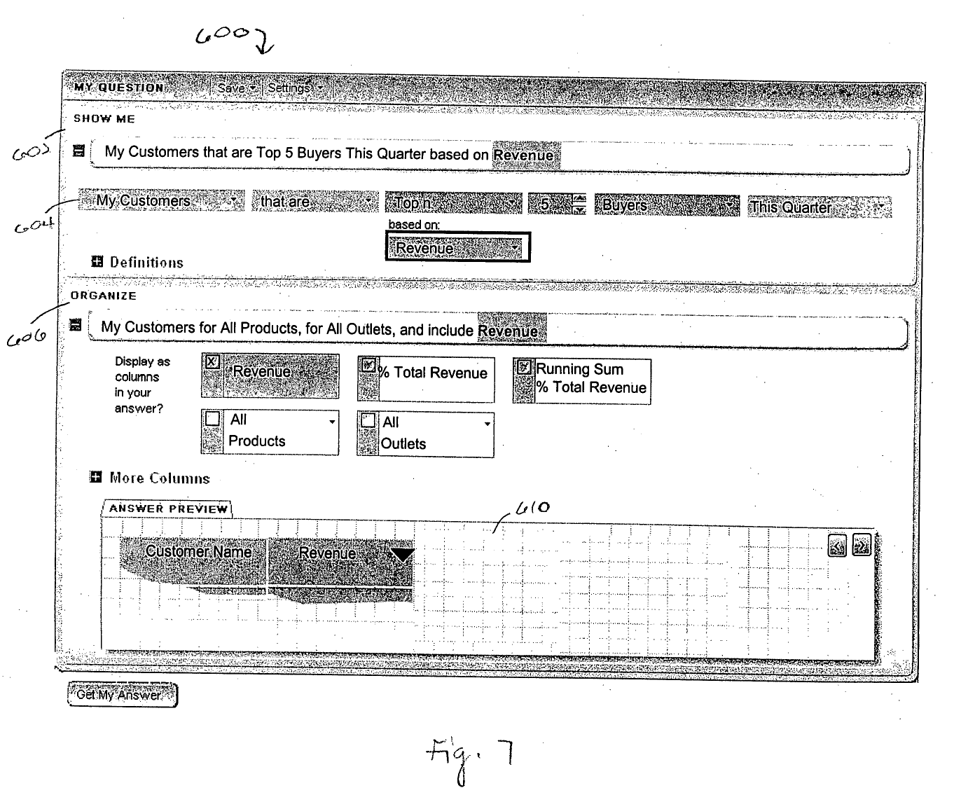

FIG. 7 generally corresponds to FIG. 6, but shows a different formed question 604, based upon the selections made in FIG. 6. The figure also illustrates a different Answer Preview 610 based upon the selections made in the formatting panel 606. The question generation module 112 may be used to create a new question, such as shown in FIG. 7, based upon previous selections, such as those made in FIG. 6. For example, the question generation module 112 may include executable instructions to identify instances when certain intermediate selections result in a certain final query. Subsequently, when the same intermediate selections are chosen, the question generation module 112 may automatically supply the certain final query. Any such predictive question may be altered through the selectable components, if necessary, to meet the user's current query objectives.

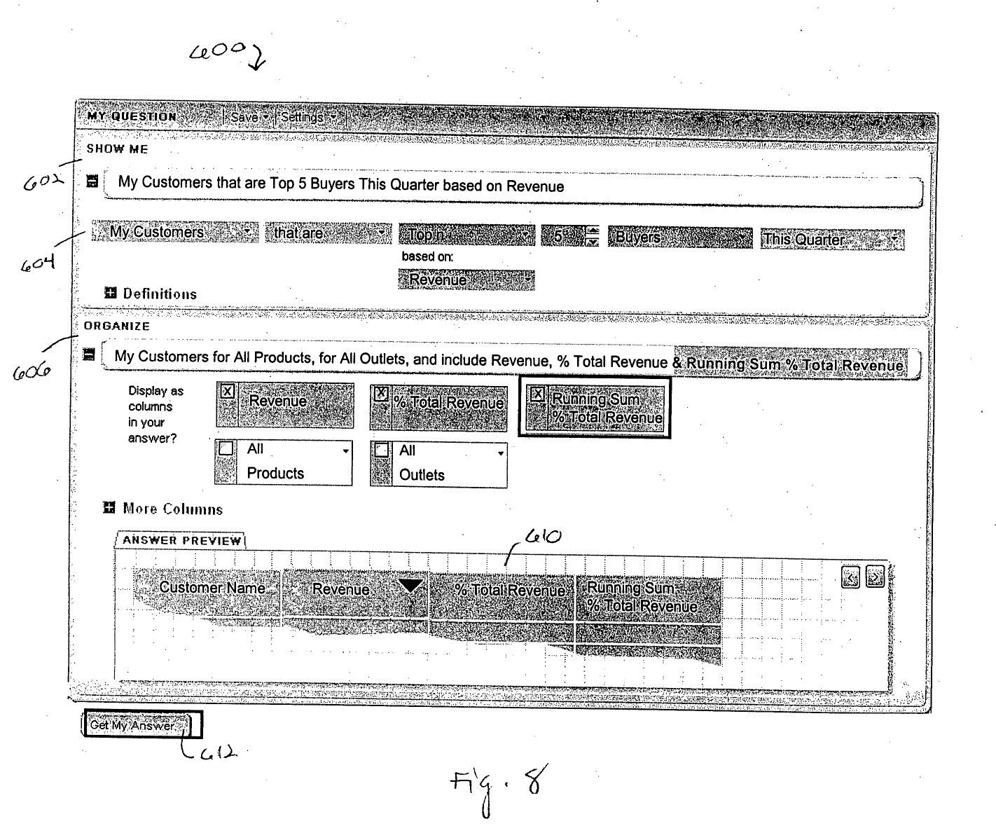

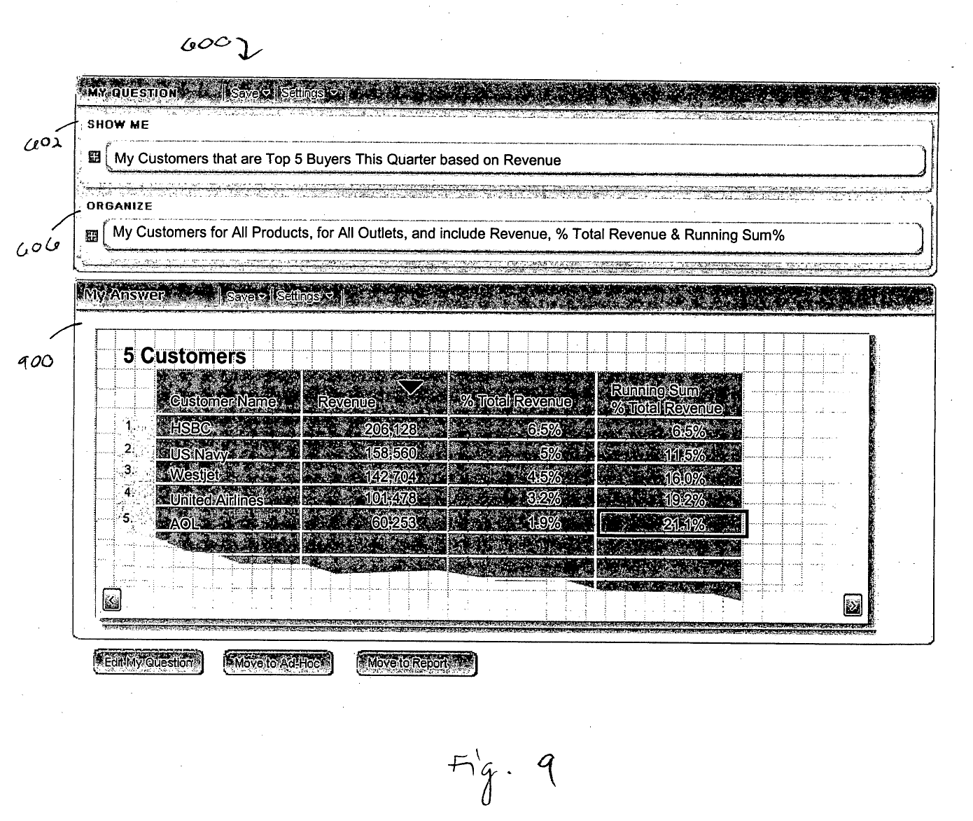

FIG. 8 generally corresponds to FIG. 7, but shows different selections made in the formatting panel 606. Thus, the Answer Preview field 610 has a different appearance. FIG. 8 also illustrates that the “Get My Answer” button 612 is highlighted for selection. This operation results in the production of an answer, as shown in FIG. 9. FIG. 9 illustrates the final question in question panel 602, the final organizational schema as shown in formatting panel 606, and the answer, as shown in answer panel 900.

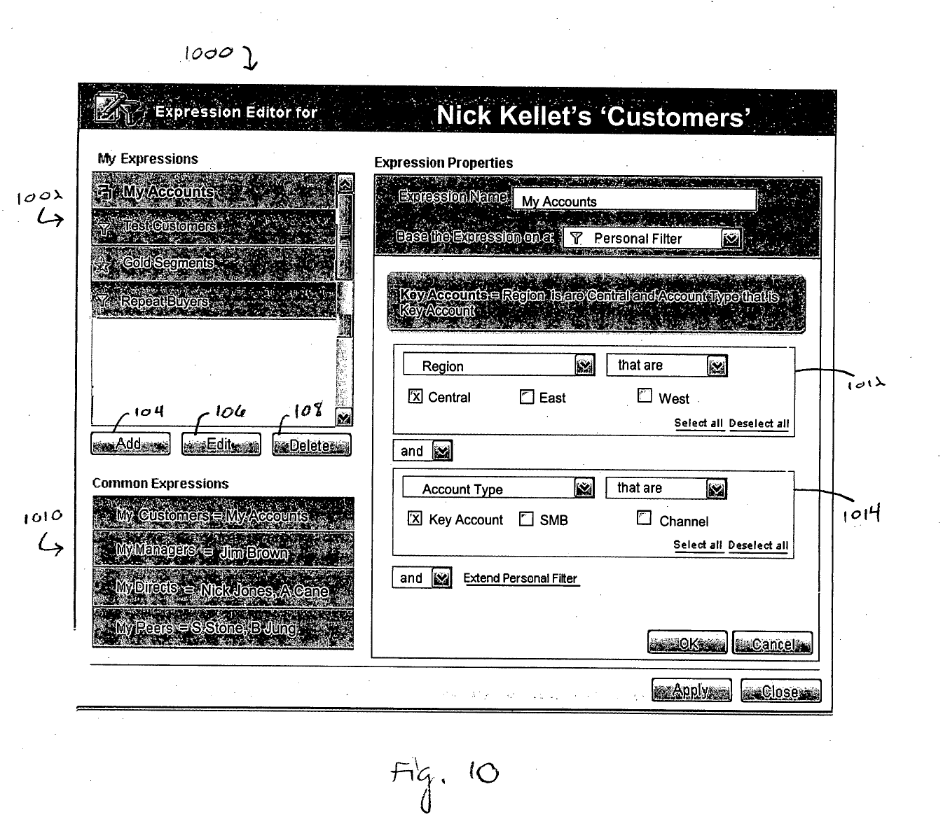

FIG. 10 illustrates an expression editor 1000 utilized in accordance with an embodiment of the invention. In this example, the expression editor is used to customize questions associated with a user's customers. A “My Expressions” block 1002 allows for the characterization of different customers. In this example, the customers are characterized as “My Accounts”, “Test Customers”, “Gold Segments”, and “Repeat Buyers”. Add, Edit, and Delete buttons, 1004, 1006, and 1008, respectively, are used to alter the contents of block 1002.

A “Common Expressions” block 1010 is also supplied. This block allows for alternate characterizations of customers. So, for example, the customers may be classified as customers of “My Managers”, “My Direct (Reports)”, and “My Peers”. The invocation of common expressions allows a user to access questions used by others in an organization.

FIG. 10 also illustrates that expression properties are configurable. As shown in FIG. 10 in block 1012, a central region may be designated as a region of interest. Characterization of an account may also be established through block 1014.

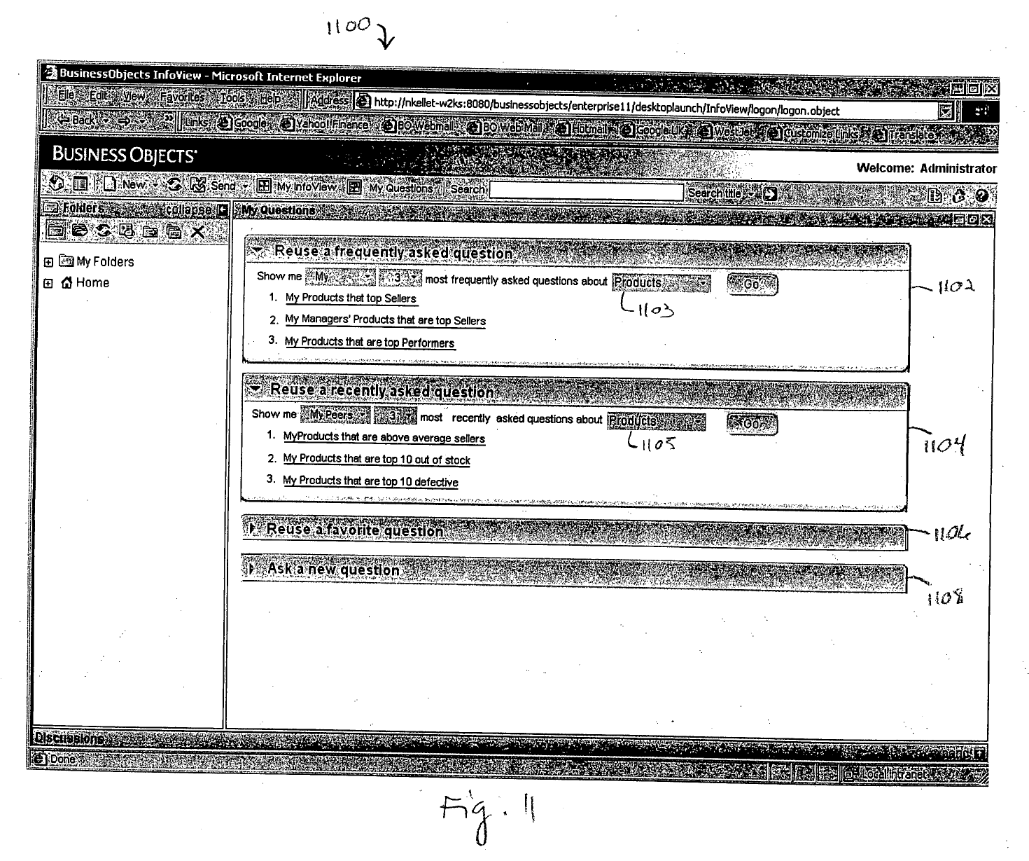

FIG. 11 illustrates a browser-based GUI 1100 that may be used in accordance with another embodiment of the invention. The GUI 110 includes a block 1102 specifying frequently asked questions. The questions shown in FIG. 11 are those of the user, but questions of another user may also be displayed. Observe the pull-down menus (e.g., 1103) that allow for alteration of the type of frequently asked question.

The GUI 1000 may be formed using the GUI module 114 in combination with the question generation module 112. In particular, the GUI module 114 may be used to control the visual appearance of the display, while the question generation module 112 may be used to supply and store expressions and expression properties.

FIG. 11 also shows a block 1104 specifying recently asked questions. In this example, the most recently asked questions relate to “My Peers 3 most recently asked questions about Products”. Thus, frequently asked questions of another are requested. Recall that “My Peers” was specified in block 1010 of FIG. 10. Pull-down menus (e.g., 1105) allow different types of recently asked questions to be presented.

FIG. 11 also illustrates a block 1106 for reusing a favorite question and a block 1108 to form a new question. The GUI 1100 may be formed using the GUI module 114 in combination with the question generation module 112. In particular, the GUI module 114 may be used to control the visual appearance of the display, while the question generation module 112 may be used to supply the various questions.

The invention provides for structured text-based questions, which are familiar to users. Note that the operation of the invention commences with an existing question. Thus, the user is not provided with a blank screen, which must be filled. Instead, the user has a starting point to direct his or her actions. The invention provides text queries that are limited (i.e., limited to the selectable components displayed) and mutually constraining (i.e., the selectable components are constrained to those components that will result in a valid query that can be applied to the data source). The question validity module 116 insures that only valid queries can be generated based upon the selectable components supplied to the user. Thus, based upon a set of currently selected components, the remaining selectable components maybe altered to insure that a valid query could be generated. The matrix of selectable components for any given text-query may be determined beforehand. Therefore, the invention can operate in a dynamic manner without significant computational expense.

The invention provides a visual and semantic metaphor to build questions to define sets of data. The visual and semantic metaphor allows non-technically trained users to obtain the data that they need in an intuitive manner. The question validity module 116 insures correct and unambiguous semantics at all times. Thus, run-time errors do not occur.

Many refinements of the disclosed technology are possible. For example, when a user alters a sentence component, the visible appearance of the altered sentence component may be modified (e.g., through highlighting, bolding, italics, different font, and the like). This allows the user to track and understand the impact of altering sentence components.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium storing executable instructions to deterministically construct a text question for application to a data source, comprising executable instructions to:
supply a user with an initial text question;
allow said user to alter a sentence component of said text question to form an altered sentence component;
identify when said altered sentence component in combination with remaining sentence components creates an invalid question and supplying sentence components to insure selection of a valid question;
construct from said initial text question and at least one altered sentence component, a data source query;
apply said data source query to a data source to produce data results; and
present said data results to said user.

2. The computer readable medium of claim 1 further comprising executable instructions to add a plurality of selectable sentence components in response to said altered sentence component, wherein each selectable sentence component insures that only a valid question may be subsequently selected.

3. The computer readable medium of claim 1 wherein said executable instructions to allow include executable instructions to supply a pull-down menu of sentence components that may be altered.

4. The computer readable medium of claim 1 wherein said executable instructions to supply include executable instructions to supply a user with an initial text question with a sentence component selected from a subject, a verb, a predicate noun and a time period.

5. The computer readable medium of claim 1 further comprising executable instructions to offer said user a plurality of formatting options for said data results.

6. The computer readable medium of claim 5 wherein said executable instructions to offer include executable instructions to offer formatting options corresponding to one or more of said sentence components.

7. The computer readable medium of claim 5 wherein said executable instructions to offer include executable instructions to offer formatting options that are not specified by said sentence components.

8. The computer readable medium of claim 1 further comprising executable instructions to store said initial text question and at least one altered sentence component as a customized question.

9. The computer readable medium of claim 8 wherein said executable instructions to supply include executable instructions to supply a user with a previously formed customized question.

10. The computer readable medium of claim 8 wherein said executable instructions to supply include executable instructions to supply a user with a previously formed customized question created by said user.

11. The computer readable medium of claim 10 wherein said executable instructions to supply include executable instructions to supply a user with a previously formed customized question created by a different user than said user.

12. The computer readable medium of claim 8 wherein said executable instructions to supply include executable instructions to supply a user with a frequently used customized question.

13. The computer readable medium of claim 1 further comprising executable instructions to modify the visible appearance of an altered sentence component.

14. A method of deterministically constructing a text question for application to a data source, comprising:
supplying a user with an initial text question;
allowing said user to alter a sentence component of said text question to form an altered sentence component;
identifying when said altered sentence component in combination with remaining sentence components creates an invalid question and supplying sentence components to insure selection of a valid question;
constructing from said initial text question and at least one altered sentence component, a data source query;
applying said data source query to a data source to produce data results; and
presenting said data results to said user.

15. The method of claim 14 further comprising offering formatting options corresponding to one or more of said sentence components and formatting options that are not specified by said sentence components.

16. The method of claim 14 wherein supplying includes supplying a user with a previously formed customized question.

17. The method of claim 14 wherein supplying includes supplying a user with a previously formed customized question created by said user.

18. The method of claim 14 wherein supplying includes supplying a user with a previously formed customized question created by a different user than said user.

19. The method of claim 14 wherein supplying includes supplying a user with a frequently used customized question.

20. The method of claim 14 wherein supplying includes supplying a user with a recently asked customized question.

21. The method of claim 14 wherein supplying includes supplying a user with a question of predicted relevance to said user.
